(19) United States
(12) Patent Application Publication
(10) Pub. No.: US 2016/0108877 A1
(43) Pub. Date: Apr. 21, 2016

(54) FUEL INJECTION NOZZLE

(71) Applicant: DENSO CORPORATION, Kariya-city (JP)

(72) Inventors: Yuuta HASHIMOTO, Nishio-city (JP); Fumiaki ARIKAWA, Okazaki-city (JP); Kazufumi SERIZAWA, Obu-city (JP)

(21) Appl. No.: 14/865,348

(22) Filed: Sep. 25, 2015

(30) Foreign Application Priority Data
Oct. 20, 2014 (JP) 2014-213832

(51) Int. Cl. F02M 61/10

(52) U.S. Cl. CPC F02M 61/10

(57) ABSTRACT

A fuel injection nozzle of the present disclosure is a multi-hole type fuel injection nozzle where a plurality of injection holes are arranged along a circumferential direction about an axis of a nozzle body, and inject fuel radially outward from the axis of the nozzle body. Among two of the plurality of injection holes that are mutually adjacent along the circumferential direction, one injection hole has a larger spray angle and a shorter spray distance as compared to an other injection hole, and the other injection hole has a smaller spray angle and a longer spray distance as compared to the one injection hole. By arranging these injection holes alternately along the circumferential direction, a required inter-spray distance may be maintained and, at the same time, a space utilization ratio may be improved.

### CROSS REFERENCE TO RELATED APPLICATION

The present application is based on Japanese Patent Application No. 2014-213832 filed on Oct. 20, 2014, disclosure of which is incorporated herein by reference.

### TECHNICAL FIELD

The present disclosure relates to a fuel injection nozzle (hereinafter simply referred to as a “nozzle”) that injects fuel.

### BACKGROUND

Conventionally, a multi-hole type fuel injection nozzle, which injects fuel from a plurality of injection holes arranged along a circumferential direction of a nozzle body, is known.

In such a fuel injection nozzle, in order to increase the proportion of the combustion chamber occupied by fuel sprays (i.e., a space utilization ratio), for example, spray angles of all injection holes may be widened.

In order to widen the spray angles, one method is to, for example, increase the diameter of an exit of the injection holes relative to the diameter of an entrance of the injection holes (refer to JP 2013-249826 A).

However, from an emissions deterioration point of view, there is a limit as to how much the space utilization ratio may be increased by widening the spray angles of all injection holes. This is because the distance between neighboring sprays must be set as equal to or above a minimum inter-spray distance W that is required to avoid causing emissions deterioration such as smoke (hereinafter referred to as a “required inter-spray distance W”).

### SUMMARY

In view of the above points, it is an object of the present disclosure to provide a fuel injection nozzle that can increase the space utilization ratio of a combustion chamber without causing emissions deterioration.

A fuel injection nozzle of the present disclosure includes a nozzle body having a plurality of injection holes for injecting fuel, and a needle housed within the nozzle body and movable in an axial direction, the needle opening and closing the plurality of injection holes. The fuel injection nozzle is a multi-hole type fuel injection nozzle where the plurality of injection holes are arrange along a circumferential direction about an axis of the nozzle body, and inject fuel radially outward from the axis of the nozzle body.

Further, in the fuel injection nozzle of the present disclosure, among two of the plurality of injection holes that are mutually adjacent along the circumferential direction, one injection hole has a larger spray angle and a shorter spray distance as compared to an other injection hole, and the other injection hole has a smaller spray angle and a longer spray distance as compared to the one injection hole.

Accordingly, by alternately arranging, along the circumferential direction, injection holes which form wide-angle sprays with injection holes which form high-penetration sprays, a distance between corresponding injection holes may be maintained and, at the same time, a space utilization ratio may be improved.

### BRIEF DESCRIPTION OF THE DRAWINGS

The disclosure, together with additional objectives, features and advantages thereof, will be best understood from the following description, the appended claims and the accompanying drawings, in which:

FIG. 1 is a cross-section view showing an entire fuel injection nozzle;

FIG. 2 is an enlarged view showing a portion of FIG. 1;

FIG. 3 is a cross-section view along the line of FIG. 2;

FIG. 4 is an explanatory view showing shapes and effects of sprays;

FIG. 5 is a graph comparing spray volumes between a first embodiment and a reference example;

FIG. 6 is a cross-section view showing a portion of a fuel injection nozzle;

FIG. 7 is a cross-section view showing a portion of a fuel injection nozzle;

FIG. 8 is a cross-section view showing a portion of a fuel injection nozzle;

FIG. 9 is a cross-section view showing a portion of a fuel injection nozzle;

FIG. 10 is a cross-section view showing a portion of a fuel injection nozzle;

FIG. 11 is an explanatory view showing spray shapes of a reference example; and

FIG. 12 is an explanatory view showing spray shapes of a modification of the reference example.

### DETAILED DESCRIPTION

Various embodiments of the present disclosure will be explained in detail below.

### First Embodiment

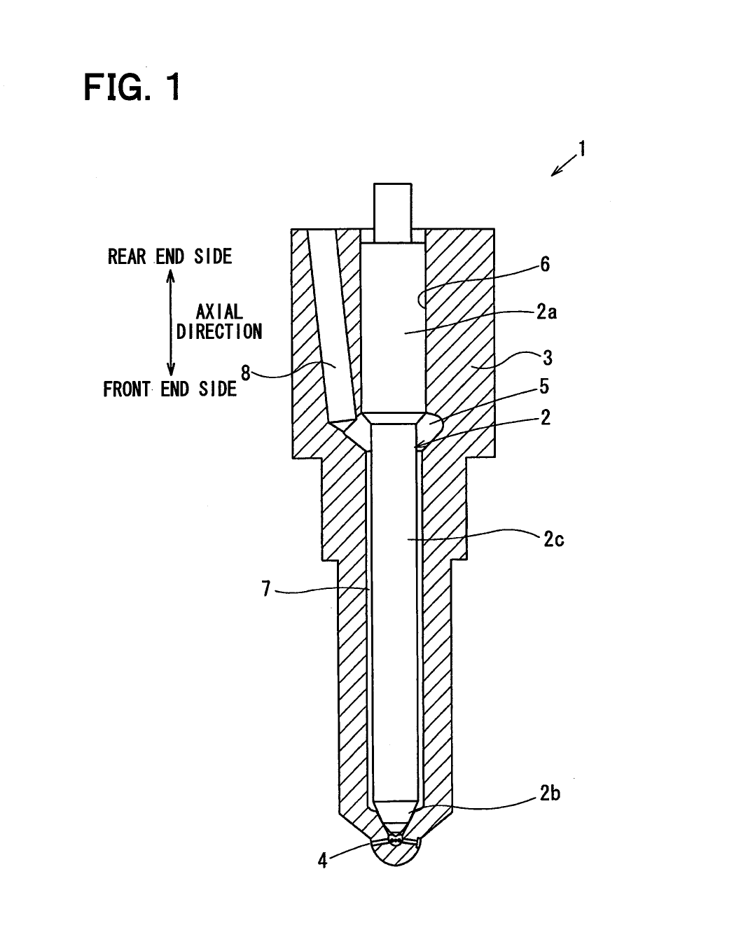

The configuration of a fuel injection nozzle 1 (hereinafter, “nozzle 1”) according to the first embodiment will be explained with reference to FIGS. 1 to 3.

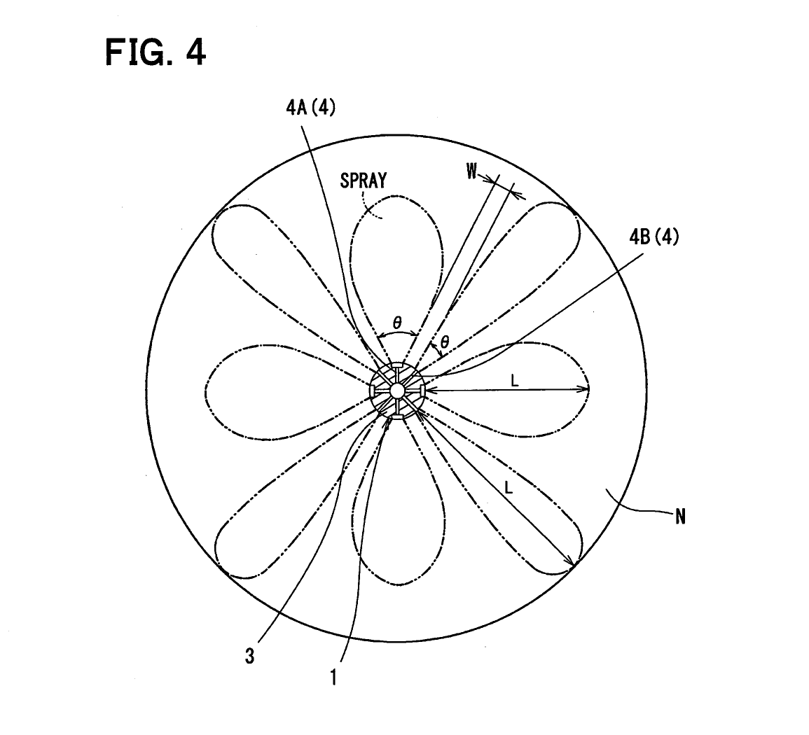

The nozzle 1 injects fuel into a combustion chamber N (see FIG. 4), and is combined with an actuator (not illustrated) to form a fuel injection valve. The actuator drives the nozzle 1 to open and close the nozzle 1. Further, the fuel injection valve may be, for example, an in-cylinder direction injection valve mounted in an internal combustion engine (not illustrated) that injects fuel at high pressures exceeding 100 MPa.

Further, the actuator may drive a valve body of the nozzle 1 (i.e., a needle 2 as will be explained later) by increasing and decreasing a back pressure that operates the valve body. Here, the actuator may control the back pressure through energizing of a coil (not illustrated), which generates a magnetic force used to open and close a back pressure chamber (not illustrated).

In addition, the fuel injection valve may be combined with a fuel supply pump (not illustrated) and an accumulator (not illustrated) to form an accumulator-type fuel supply device. Here, the fuel supply pump pressurizes fuel to a high pressure and discharges the high pressure fuel. Further, the accumulator stores the fuel discharged from the fuel supply pump in a high pressure state. In this regard, the accumulator-type fuel supply device delivers the high pressure fuel from the accumulator by injecting the fuel into cylinders.

First, the overall configuration of the nozzle 1 will be explained with reference to FIG. 1.

As shown in FIG. 1, the nozzle 1 includes a cylindrical nozzle body 3 and a needle 2. The needle 2 is housed within the nozzle body 3 and movable in an axial direction, and acts as a valve body. Further, injection holes 4 are formed in the nozzle body 3. The injection holes 4 are opened and closed by axial movement of the needle 2 within the nozzle body 3, thereby starting and stopping fuel injection.

The needle 2 includes a sliding shaft portion 2a, a tip portion 2b, and a cylinder portion 2c. The sliding shaft portion 2a is supported by the nozzle body 3 so as to be slidable in the axial direction. The tip portion 2b is conical and substantially acts as a valve portion. The cylinder portion 2c extends in the axial direction and is disposed between the sliding shaft portion 2a and the tip portion 2b.

The inner periphery of the nozzle body 3 is cylindrical-shaped and extends in the axial direction, and includes a closed tip portion. Further, a portion of the inner periphery of the nozzle body 3 expands in the radial direction to form a fuel collector 5. The fuel collector 5 temporarily stores fuel that is to be injected.

A sliding opening 6 is formed in the inner periphery of the nozzle body 3. The sliding opening 6 is positioned toward a rear end in the axial direction with respect to the fuel collector 5, and slidably supports the sliding shaft portion 2a. A fuel passage 7 is also formed in the inner periphery of the nozzle body 3. The fuel passage 7 is positioned toward a front end in the axial direction with respect to the fuel collector 5. Further, the fuel passage 7 is cylindrical shaped, and houses the tip portion 2b and the cylinder portion 2c. A fuel passage 8 is formed in the nozzle body 3. The fuel passage 8 is connected to the fuel collector 5, and guides fuel, which is received from the accumulator, to the fuel collector 5.

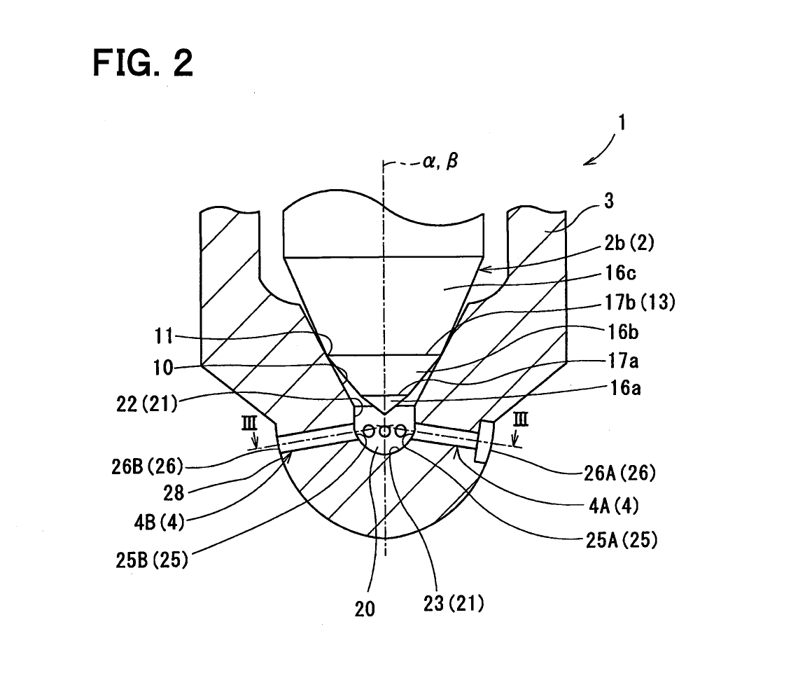

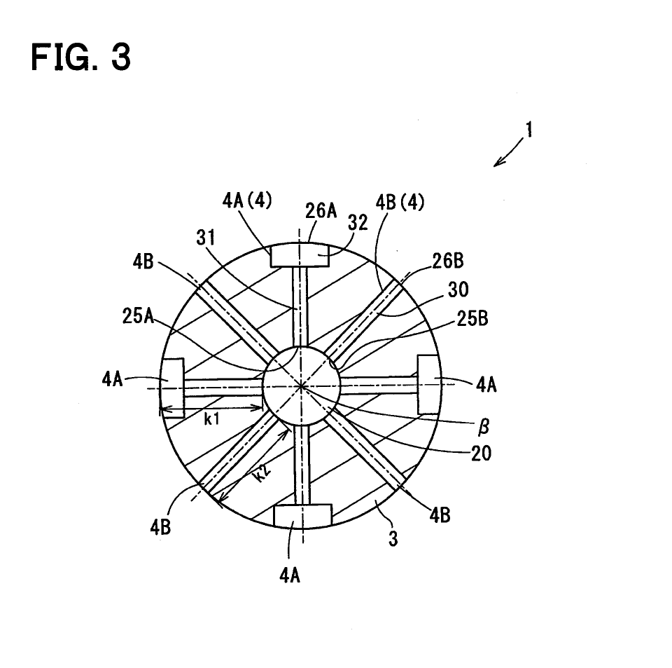

Next, the tip portion 2b of the nozzle 1 will be explained in detail with reference to FIGS. 2 and 3.

The tip area of the nozzle body 3 includes an inner wall surface that is coaxial with an axis β of the nozzle body 3. The inner wall surface includes a conical surface 10 that decreases in diameter along the axial direction toward the front end side. Further, the inner wall surface envelopes the inner peripheral tip of the nozzle body 3.

Here, the conical surface 10 includes a seat position 11. Specifically, the seat position 11 is a portion of the inner wall surface of the nozzle body 3. Further, the axial tip area of the needle 2 includes a seat portion 13 that abuts with and separates from the seat position 11.

The seat portion 13 is formed on an outer wall surface of the tip portion 2b of the needle 2.

The outer wall surface of the tip portion 2b of the needle 2 may include three different conical surfaces 16a, 16b, and 16c. The conical surfaces 16a, 16b, and 16c are coaxial with each other and are disposed in succession from the tip of the needle 2 along the axial direction toward the rear end side. An angle formed between the generatrix of the conical surface 16a and an axis α of the needle 2 is greater than an angle formed between the generatrix of the conical surface 16b and the axis α of the needle 2, which is in turn greater than an angle formed between the generatrix of the conical surface 16c and the axis α of the needle 2. Here, an intersection line 17a is defined between the conical surfaces 16a and 16b, and an intersection line 17b is defined between the conical surfaces 16b and 16c. Each of the intersection lines 17a and 17b form a circle that is perpendicular to the axis α. Further, the intersection line 17b acts as the seat portion 13.

A suction chamber 20 is formed in an inner peripheral region of the nozzle body 3. The suction chamber 20 is positioned toward the front end in the axial direction with respect to the seat position 11.

Specifically, the suction chamber 20 defines an open space that is positioned toward the front end in the axial direction with respect to the conical surface 10, and is enclosed by the inner wall of the nozzle body 3. Further, the suction chamber 20, which is formed in the nozzle body 3, includes the injection holes 4 which penetrate from inside of the nozzle body 3 to outside of the nozzle body 3.

The suction chamber 20 of the present embodiment is a so-called mini-suction type. Specifically, the inner wall of the nozzle body 3 that forms the suction chamber 20 (hereinafter, referred to as a “suction inner wall 21”) includes a cylindrical surface 22 that extends in the axial direction and a hemispherical surface 23 connected to the tip of the cylindrical surface 22. The suction inner wall 21 envelopes the inner peripheral tip of the nozzle body 3.

The injection holes 4 open at the inner wall of the nozzle body 3 at a front end side of the seat position 11 in the axial direction. Further, the injection holes 4 open at the outer wall of the nozzle body 3. When the seat portion 13 separates from the seat position 11, the injection holes 4 guide fuel from the inner periphery of the nozzle body 3 to outside. In other words, when the seat portion 13 lifts from the seat position 11, a gap is formed between the seat portion 13 and the seat position 11. Next, fuel flows from the fuel passage 7 to the injection holes 4 through this gap. Then, the fuel is guided by the injection holes 4 to outside of the nozzle body 3 and thereby injected.

Hereinafter, “injection entrances 25” refer to the openings of the injection holes 4 at the inner wall of the nozzle body 3, and “injection exits 26” refer to the openings of the injection holes 4 at the outer wall of the nozzle body 3.

In the present embodiment, the injection entrances 25 of the injection holes 4 are open at the suction inner wall 21. Further, the injection exits 26 are open at the outer wall of the nozzle body 3 that forms the suction chamber 20 (hereinafter, “suction outer wall 28”).

The nozzle 1 of the present embodiment is a multi-hole type nozzle where a plurality of the injection holes 4 are arranged along a circumferential direction about the axis β of the nozzle body 3.

In the present embodiment, eight of the injection holes 4 are provided, and the flow path axes of the eight injection holes 4 are positioned so as to extend radially outward from the axis β of the nozzle body 3 (see FIG. 3). In other words, the injection holes 4 inject fuel radially outward from the axis β of the nozzle body 3.

Further, in the present embodiment, a contour line of the suction inner wall 21, which is where the injection entrances 25 open, forms a circle that is centered on the axis β when viewed along the axial direction. A contour line of the suction outer wall 28, which is where the injection exits 26 open, also forms a circle that is centered on the axis β when viewed along the axial direction.

As a result, the injection entrances 25 are disposed on a circle that is coaxial with the axis β of the nozzle body 3, and are approximately equally spaced from each other along the circumferential direction. Similarly, the injection exits 26 are also disposed on a circle that is coaxial with the axis β of the nozzle body 3, and are approximately equally spaced from each other along the circumferential direction

In the nozzle 1 of the present embodiment, the plurality of injection holes 4 include two types of injection holes 4A and 4B disposed alternately along the circumferential direction about a central axis of the nozzle body 3.

Specifically, the injection holes 4A have a larger spray angle θ and a shorter spray distance L as compared to the injection holes 4B. That is, the injection holes 4B have a smaller spray angle θ and a longer spray distance L as compared to the injection holes 4A.

As shown in FIG. 4, the spray angle θ is a conical angle of the fuel spray which is injected from the injection holes 4. Further, the spray distance L is a distance traveled by the leading edge of the spray.

In other words, among two of the injection holes 4 that are mutually adjacent along the circumferential direction, one injection hole (i.e., one of the injection holes 4A) has a larger spray angle θ and a shorter spray distance L as compared to an other injection hole (i.e., one of the injection holes 4B), while the other injection hole (i.e., one of the injection holes 4B) has a smaller spray angle θ and a longer spray distance L as compared to the one injection hole (i.e., one of the injection holes 4A).

Hereinafter, the injection holes 4A and 4B of the present embodiment will be explained in detail.

In the present embodiment, since there are eight of the injection holes 4, there are four of the injection holes 4A and four of the injection holes 4B. Further, the injection holes 4A and the injection holes 4B are arranged alternately with each other along the circumferential direction.

In the below discussion, the injection entrances 25 of the injection holes 4A are referred to as injection entrances 25A, and the injection exits 26 of the injection holes 4A are referred to as injection exits 26A. Similarly, the injection entrances 25 of the injection holes 4B are referred to as injection entrances 25B, and the injection exits 26 of the injection holes 4B are referred to as injection exits 26B.

For the injection holes 4B, the injection entrances 25B and the injection exits 26B have the same diameter, and a straight flow path 30 having a constant flow path diameter is formed between each of the injection entrances 25B and the injection exits 26B.

For the injection holes 4A, the injection exits 26A are larger than the injection entrances 25A. Further, the injection entrances 25A and the injection entrances 25B have the same diameter. Each of the injection holes 4A may be, for example, formed by a straight flow path 31 having the same diameter as the injection entrances 25A and connected to a downstream straight flow path 32 having the same diameter as the injection exits 26A. The straight flow path 32 may be formed by, for example, counterboring.

Further, the straight flow paths 32 may be tapered paths that gradually increase in diameter toward the injection exits 26A.

In addition, an injection hole length k1 of the injection holes 4A is equal to an injection hole length k2 of the injection holes 4B. Here, the injection hole length k1 is defined as the distance along the flow path axis from each of the injection entrances 25A to each of the injection exits 26A. Further, the injection hole length k2 is defined as the distance along the flow path axis from each of the injection entrances 25B to each of the injection exits 26B.

By forming the injection holes 4A and 4B in the above described manner, the injection holes 4A form wide-angle sprays having a larger spray angle θ as compared to the injection holes 4B. Further, the injection holes 4B form high-penetration sprays having a smaller spray angle θ and longer spray distance L as compared to the injection holes 4A.

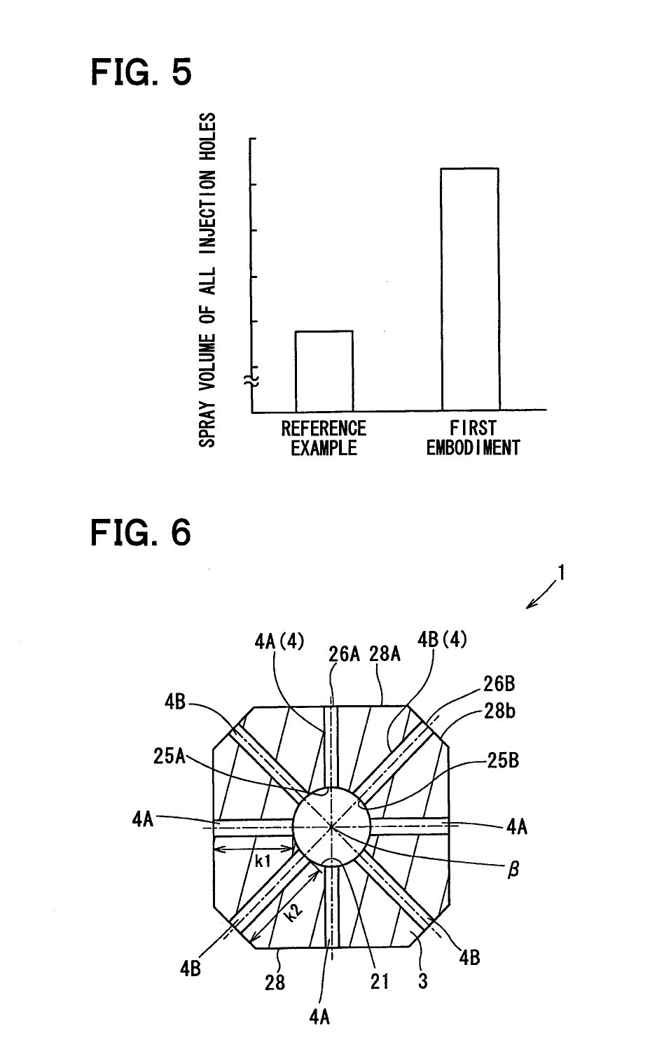

The present embodiment exhibits at least the following effects, which will be explained with reference to FIGS. 4 and 5.

As shown in FIG. 4, according to the present embodiment, the required inter-spray distance W may be maintained and, at the same time, the space utilization ratio of a combustion chamber N may be improved.

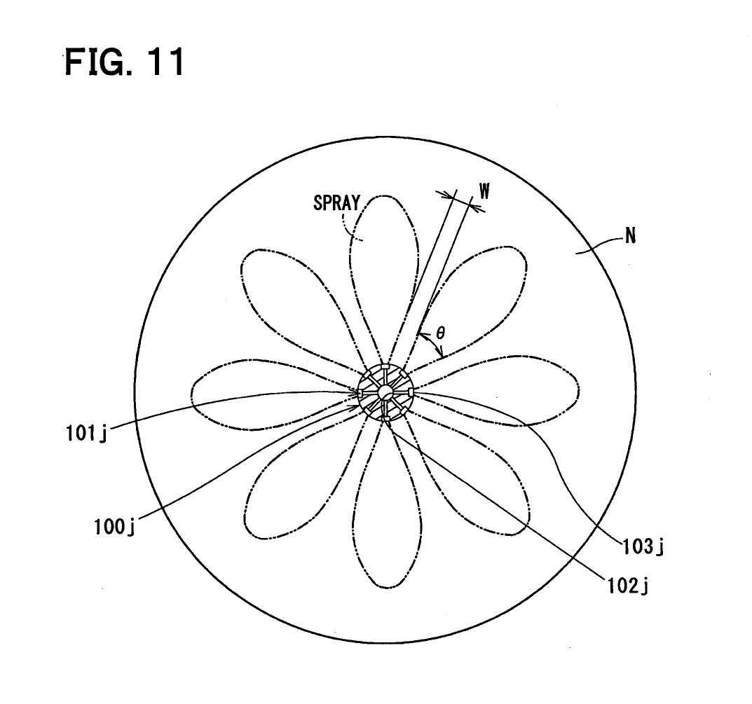

In contrast, FIG. 11 shows a reference example fuel injection nozzle 100j. In this case, even if the spray angle θ of all the injection holes 101j is increased, there is a limit when considering the required inter-spray distance W. That is, it may be difficult to improve the space utilization ratio of the combustion chamber N by simply increasing the spray angle θ.

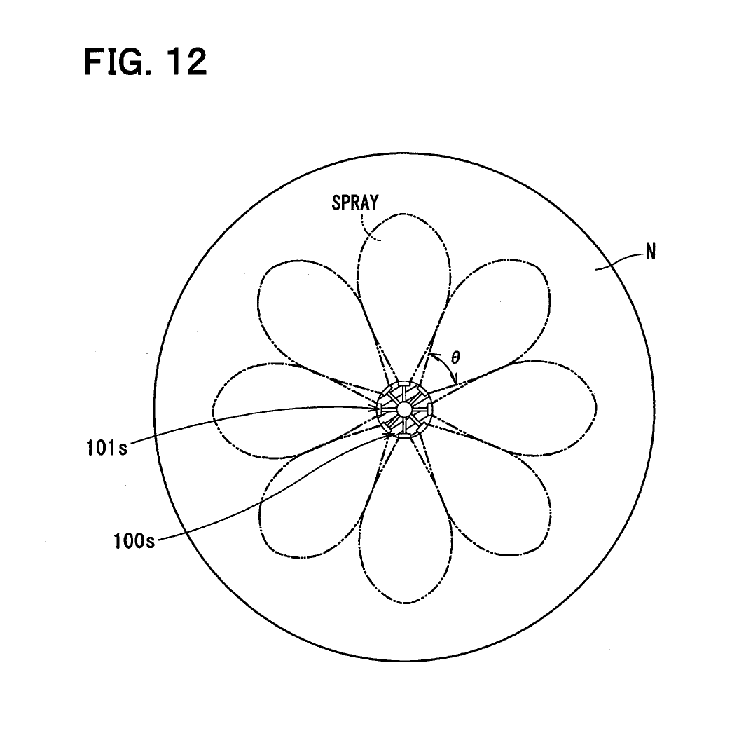

For example, FIG. 12 shows a modification of the reference example as a fuel injection nozzle 100s. Here, in an attempt to improve the space utilization ratio of the combustion chamber N, the spray angle θ is excessively widened, and as a result, neighboring injection holes 101s interfere with each other, and emissions deterioration such as smoke may be caused.

In other words, trying to improve the space utilization ratio by simply widening the spray angle θ may, on the contrary, cause emissions deterioration such as smoke. Further, if the spray angle θ is widened, the spray penetration force is removed, and the space utilization ratio near the outer edge of the combustion chamber N (i.e., near the inner wall surface of the cylinder) may decrease.

As described above, in the reference example of FIG. 11, an attempt is made to improve the space utilization ratio by widening the spray angle θ of all injection holes 101j. However, in order to maintain the required inter-spray distance W, which is the minimum inter-spray distance that is required to avoid causing emissions deterioration such as smoke, there is a limit as to how much the spray angle θ may be widened. Thus, there is a limit as to how much the space utilization ratio may be improved by only widening the spray angle θ of all injection holes 101j.

Conversely, in the present embodiment, the injection holes 4A which form wide-angle sprays and the injection holes 4B which form high-penetration sprays are arranged alternately with each other along the circumferential distance. As a result, the required inter-spray distance W may be maintained and, at the same time, the space utilization ratio of may be improved.

In other words, for the injection holes 4A, since the spray angle θ of neighboring injection holes 4B is small, the required inter-spray distance W is maintained and, at the same time, a greater spray angle θ than that of the reference example may be used. Meanwhile, for the injection holes 4B, by forming a high-penetration spray, the spray may reach the outer edge of the combustion chamber N (i.e., near the inner wall surface of the cylinder).

FIG. 5 shows a comparison of the total spray volume of all injection holes between the present embodiment and the reference example. The spray volume is also an indicator the space utilization ratio.

Further, for each injection hole 101j of the nozzle 100j in the reference example, an injection exit 103j has a greater diameter than an injection entrance 102j. Further, each injection hole 101j is formed by a straight flow path having the same diameter as the injection entrance 102j connected to a downstream straight flow path having the same diameter as the injection exit 103j. Each injection entrance 102j has the same diameter as the injection entrances 25A and 25B of the present embodiment.

For the comparison of FIG. 5, the diameters of the injection exits 103j and the injection exits 26A are each set so as to maximize the spray volume while still maintaining the required inter-spray distance W, in order to compare the reference example with the present embodiment.

While maintaining the required inter-spray distance W, the diameter of the injection exits 26A may be set to be larger than that of the injection exits 103j. This is because, compared to each injection hole 4A, the spray angle of the neighboring injection holes 4B is narrower.

Thus, as shown in FIG. 5, the spray volume of all injection holes is larger for the present embodiment as compared to the reference example. As such, the space utilization ratio is greater.

In the reference example, if the space utilization ratio is increased by only widening the spray angle θ, then the required inter-spray distance W must be ignored and thus emissions deterioration such as smoke will occur.

In contrast, in the present embodiment, the required inter-spray distance W is maintained without causing emissions deterioration such as smoke, and a greater space utilization ratio may be obtained as compared to the reference example.

### Second Embodiment

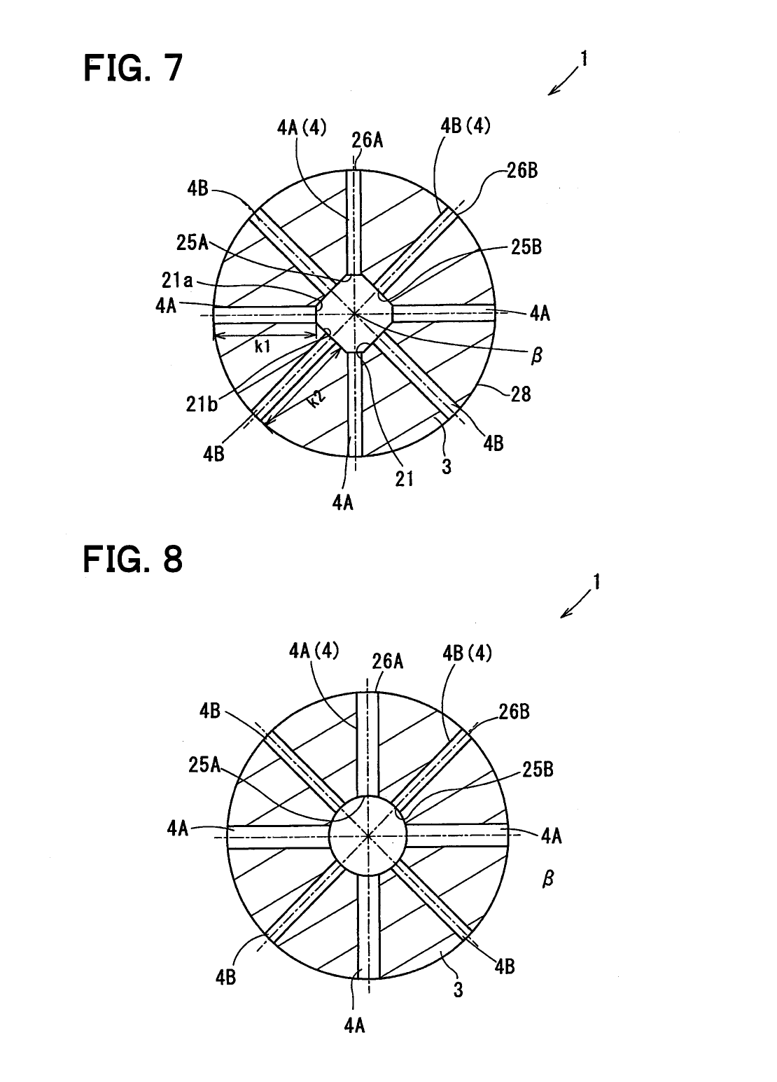

Differences between the nozzle 1 of the second embodiment and that of the first embodiment will be explained with reference to FIGS. 6 and 7.

In the present embodiment, the shapes of the injection holes 4A and 4B differ from the first embodiment.

Specifically, for the injection holes 4A of the present embodiment, the injection entrances 25A and the injection exits 26A have the same diameter, and a straight flow path having a constant flow path diameter is formed between each injection entrance 25A and injection exit 26A.

For the injection holes 4B, similar to the first embodiment, the injection entrances 25B and the injection exits 26B have the same diameter, and a straight flow path having a constant flow path diameter is formed between each injection entrance 25B and injection exit 26B.

Further, in the present embodiment, the injection hole length k1 of the injection holes 4A is shorter than the injection hole length k2 of the injection holes 4B.

For example, as shown in FIG. 6, a contour line of the suction inner wall 21, which is where the injection entrances 25A and 25B open, forms a circle that is centered on the axis β when viewed along the axial direction. A contour line of the suction outer wall 28, which is where the injection exits 26A and 26B open, forms an octagon when viewed along the axial direction.

Further, the injection exits 26A and 26B open at respective faces of the octagon. Specifically, the injection exits 26A open at respective faces 28a, while the injection exits 26B open as respective faces 28b. Here, a distance between each face 28a and the axis β of the nozzle body 3 is shorter, in the radial direction, than a distance between each face 28b and the axis β of the nozzle body 3.

Further, as another example shown in FIG. 7, a contour line of the suction inner wall 21, which is where the injection entrances 25A and 25B open, forms an octagon when viewed along the axial direction. A contour line of the suction outer wall 28, which is where the injection exits 26A and 26B open, form a circle that is centered on the axis β when viewed along the axial direction.

In addition, the injection entrances 25A and 25B open at respective faces of the octagon. Specifically, the injection entrances 25A open at respective faces 21a, while the injection entrances 25B open at respective faces 21b. Here, a distance between each face 21a and the axis of the nozzle body 3 is longer, in the radial direction, than a distance between each face 21b and the axis β of the nozzle body 3.

By forming the injection holes 4A and the injection holes 4B in the above described manner, the injection holes 4A form wide-angle sprays having a larger spray angle θ as compared to the injection holes 4B. Further, the injection holes 4B form high-penetration sprays having a smaller spray angle θ and longer spray distance L as compared to the injection holes 4A.

For this reason, the present embodiment exhibits at least the same effects as the first embodiment.

### Third Embodiment

Differences between the nozzle 1 of the third embodiment and that of the first embodiment will be explained with reference to FIG. 8.

In the present embodiment, the shapes of the injection holes 4A and 4B differ from the first embodiment.

Specifically, for the injection holes 4A of the present embodiment, the injection entrances 25A and the injection exits 26A have the same diameter, and a straight flow path having a constant flow path diameter is formed between each injection entrance 25A and injection exit 26A.

For the injection holes 4B, similar to the first embodiment, the injection entrances 25B and the injection exits 26B have the same diameter, and a straight flow path having a constant flow path diameter is formed between each injection entrance 25B and injection exit 26B.

Further, the flow path diameter of the injection holes 4A is larger than the flow path diameter of the injection holes 4B. In other words, the injection entrances 25A and the injection exits 26A are also larger than the injection entrances 25B and the injection exits 26B.

By forming the injection holes 4A and the injection holes 4B in the above described manner, the injection holes 4A form wide-angle sprays having a larger spray angle θ as compared to the injection holes 4B. Further, the injection holes 4B form high-penetration sprays having a smaller spray angle θ and longer spray distance L as compared to the injection holes 4A.

For this reason, the present embodiment exhibits at least the same effects as the first embodiment.

### Fourth Embodiment

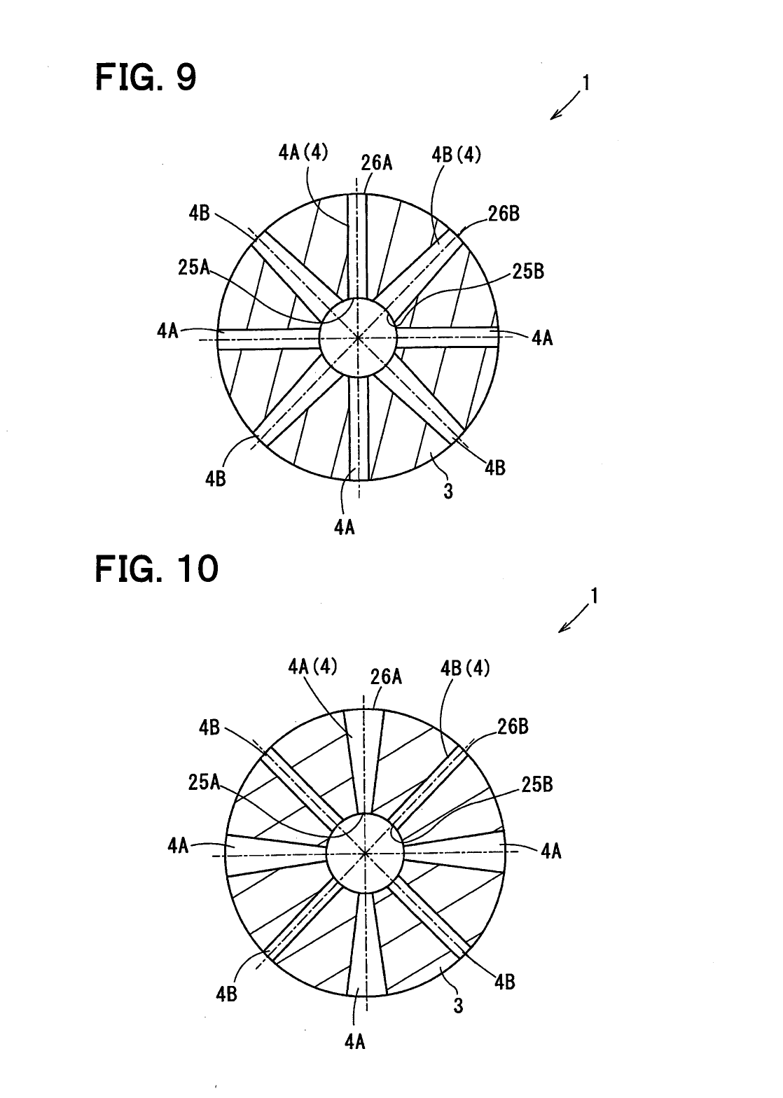

Differences between the nozzle 1 of the fourth embodiment and that of the first embodiment will be explained with reference to FIG. 9.

In the present embodiment, the shapes of the injection holes 4A and 4B differ from the first embodiment.

Specifically, for the injection holes 4A of the present embodiment, the injection entrances 25A and the injection exits 26A have the same diameter, and a straight flow path having a constant flow path diameter is formed between each injection entrance 25A and injection exit 26A.

For the injection holes 4B, the injection exits 26B have a smaller diameter than the injection entrances 25B, and a tapered flow path having a diameter that decreases toward the injection exits 26B is formed between each injection entrance 25B and injection exit 26B.

Further, the injection exits 26A and the injection exits 26B have the same diameter, while the injection entrances 25B have a larger diameter as compared to the injection entrances 25A.

By forming the injection holes 4A and the injection holes 4B in the above described manner, the injection holes 4A form wide-angle sprays having a larger spray angle θ as compared to the injection holes 4B. Further, the injection holes 4B form high-penetration sprays having a smaller spray angle θ and longer spray distance L as compared to the injection holes 4A.

For this reason, the present embodiment exhibits at least the same effects as the first embodiment.

### Fifth Embodiment

Differences between the nozzle 1 of the fifth embodiment and that of the first embodiment will be explained with reference to FIG. 10.

In the present embodiment, the shapes of the injection holes 4A and 4B differ from the first embodiment.

Specifically, for the injection holes 4A of the present embodiment, the injection exits 26A have a larger diameter as compared to the injection entrances 25A, and a tapered flow path having a diameter that increases toward the injection exits 26A is formed between each injection entrance 25A and injection exit 26A.

For the injection holes 4B, similar to the first embodiment, the injection entrances 25B and the injection exits 26B have the same diameter, and a straight flow path having a constant flow path diameter is formed between each injection entrance 25B and injection exit 26B.

Further, the injection entrances 25A and the injection entrances 25B have the same diameter, while the injection exits 26A have a larger diameter as compared to the injection exits 26B.

By forming the injection holes 4A and the injection holes 4B in the above described manner, the injection holes 4A form wide-angle sprays having a larger spray angle θ as compared to the injection holes 4B. Further, the injection holes 4B form high-penetration sprays having a smaller spray angle θ and longer spray distance L as compared to the injection holes 4A.

For this reason, the present embodiment exhibits at least the same effects as the first embodiment.

### Other Embodiments

In the present embodiments, the two types of injection holes 4A and 4B are arranged alternately with each other along the circumferential direction. However, the present disclosure is not limited to such an arrangement, and may include any arranged where among two of the injection holes 4 that are adjacent to each other along the circumferential direction, one injection hole 4 has a larger spray angle and shorter spray distance than an other injection hole 4, while the other injection hole 4 has a smaller spray angle and longer spray distance than the one injection hole 4.

Further, the above embodiments one to five are examples where the injection holes 4A form wide-angle sprays having a larger spray angle θ as compared to the injection holes 4B, while the injection holes 4B form high-penetration sprays having a smaller spray angle θ and longer spray distance L as compared to the injection holes 4A. However, the present disclosure is not limited to the variations of the above embodiments, and other variations are also contemplated.

For example, in the second embodiment, the injection exits 26A may have a greater diameter than the injection exits 26B.

1. A multi-hole type fuel injection nozzle, comprising:
a nozzle body having a plurality of injection holes for injecting fuel; and
a needle housed within the nozzle body and movable in an axial direction, the needle opening and closing the plurality of injection holes, wherein
the plurality of injection holes are arranged along a circumferential direction about an axis of the nozzle body, and inject fuel radially outward from the axis of the nozzle body, and
among two of the plurality of injection holes that are mutually adjacent along the circumferential direction, one injection hole has a larger spray angle and a shorter spray distance as compared to an other injection hole, and the other injection hole has a smaller spray angle and a longer spray distance as compared to the one injection hole.

2. The fuel injection nozzle of claim 1, wherein
the one injection hole has a shorter injection hole length than the other injection hole.

3. The fuel injection nozzle of claim 1, wherein
an injection exit of the one injection hole has a greater diameter than an injection exit of the other injection hole.

4. The fuel injection nozzle of claim 1, wherein
an injection exit of the one injection hole has a greater diameter than an injection entrance of the one injection hole.

5. The fuel injection nozzle of claim 1, wherein
an injection exit of the other injection hole has a smaller diameter than an injection entrance of the other injection hole.

6. The fuel injection nozzle of claim 1, wherein
an injection exit of the one injection hole and an injection exit of the other injection hole have a same diameter, and
an injection entrance of the other injection hole has a greater diameter than an injection entrance of the one injection hole.
